(19) United States
(12) Patent Application Publication
(10) Pub. No.: US 2007/0023248 A1
(43) Pub. Date: Feb. 1, 2007

(54) CLUTCH ASSEMBLY

(75) Inventors: David T. Nguyen, Farmington, CT (US); John S. Hayward, Torrington, CT (US)

Correspondence Address: MICHAEL BEST & FRIEDRICH, LLP, 100 E WISCONSIN AVENUE, MILWAUKEE, WI, 53202, US

(73) Assignee: TIMKEN US CORPORATION, Torrington, CT (US)

(21) Appl. No.: 11/461,536

(22) Filed: Aug. 1, 2006

Related U.S. Application Data
(60) Provisional application No. 60/704,529, filed on Aug. 1, 2005.

(51) Int. Cl. F16D 41/08

(52) U.S. Cl. 192/43; 192/45.1; 192/47

(57) ABSTRACT

A clutch assembly that includes an input member rotatable about an axis, an output member rotatable about the axis, and an engagement member having a portion between the input and output members. The engagement member is operable to selectively couple the input and output members together for co-rotation. The clutch assembly further includes a blocking member having a base and a projection. The projection is coupled to the engagement member to substantially prevent the engagement member from coupling the input and output members together for co-rotation when the input member rotates in a first direction relative to the output member, while allowing the engagement member to couple the input and output members lor together co-rotation when the input member rotates in a second direction relative to the output member.

### CROSS-REFERENCE TO RELATED APPLICATIONS

This application claims priority to U.S. Provisional Patent Application No. 60/0704,529, filed Aug. 1, 2005, the entire contents of which are incorporated by reference herein.

### BACKGROUND

The present invention relates to clutch assemblies.

Clutch assemblies can be utilized to transmit torque from an input member to an output member. In one construction, when the input member is rotated in a first direction relative to the output member the clutch assembly engages the input member and the output member such that the input and output members rotate together, thereby transmitting torque from the input member to the output member. However, if the input member is rotated in a second direction relative to the output member, opposite the first direction, the output member will rotate, free-wheel, or overrun with respect to the input member and torque will not be transmitted from the input member to the output member.

### SUMMARY

In one embodiment the invention provides a clutch assembly that includes an input member rotatable about an axis and an output member rotatable about the axis. The clutch assembly further includes an engagement member having a portion between the input member and the output member. The engagement member is operable to selectively couple the input and output members together for co-rotation. The clutch assembly further includes a blocking member having a base and a projection that extends from the base. The projection is coupled to the engagement member to substantially prevent the engagement member from coupling the input and output members together for co-rotation (i.e., free-wheel or overrun) when the input member rotates in a first direction relative to the output member, while allowing the engagement member to couple the input and output members together for co-rotation (i.e., engage) when the input member rotates in a second direction relative to the output member.

In another embodiment, the invention provides a bi-directional clutch assembly that includes an input member rotatable about an axis and an output member rotatable about the axis. The bi-directional clutch further includes an engagement member having a portion between the input and output members. The engagement member is movable between a first axial position that enables the input and output members to generally rotate together (i.e., engage) when the input member rotates in a first direction relative to the output member and rotate with respect to each other (i.e., free-wheel or overrun) when the input member rotates in a second direction relative to the output member, and a second axial position that enables the input and output members to generally rotate together (i.e., engage) when the input member rotates in the second direction relative to the output member and rotate with respect to each other (i.e., free-wheel or overrun) when the input member rotates in the first direction relative to the output member.

In yet another embodiment the invention provides a clutch assembly that includes an input member rotatable about an axis, an output member rotatable about the axis, and an engagement member having a portion between the input and output members. The engagement member is operable to selectively couple the input and output members together for co-rotation. The clutch assembly further includes an adjustment member axially movable relative to the input member between a first position and a second position. The engagement member is prevented from coupling the input and output members together for co-rotation (i.e., free-wheel or overrun) when the adjustment member is in the first position and the engagement member is allowed to couple the input and output members together for co-rotation (i.e., engage) when the adjustment member is in the second position.

Other aspects of the invention will become apparent by consideration of the detailed description and accompanying drawings.

### BRIEF DESCRIPTION OF THE DRAWINGS

FIG. 1 is a perspective view of a clutch assembly embodying the invention with a of the clutch assembly removed for illustrative purposes.

FIG. 2 is a cross-sectional view of the clutch assembly of FIG. 1 taken along line 2-2 of FIG. 1 illustrating the clutch assembly in a disengaged position.

FIG. 3 is a cross-sectional view of the clutch assembly of FIG. 1 taken along line 3-3 of FIG. 1 illustrating the clutch assembly in an engaged position.

FIG. 4 is a perspective view of a blocking member of the clutch assembly of FIG. 1

FIG. 5 is a front view of the blocking member of the clutch assembly of FIG. 1.

FIG. 6 is a side view of the blocking member of the clutch assembly of FIG. 1.

FIG. 7 is a perspective view of an alternative construction of a clutch assembly embodying the invention with a portion of the clutch assembly removed for illustrative purposes.

FIG. 8 is an exploded view of the clutch assembly of FIG. 7.

FIG. 9 is a cross-sectional view of the clutch assembly of FIG. 7 taken along line 9-9 of FIG. 7 illustrating the clutch assembly in a disengaged position and arranged to engage in a first rotational direction.

FIG. 10 is a cross-sectional view of the clutch assembly of FIG. 7 taken along line 10-10 of FIG. 7 illustrating the clutch assembly in an engaged position in the first rotational direction.

FIG. 11 is a cross-sectional view of the clutch assembly of FIG. 7 taken along line 11-11 illustrating the clutch assembly in a disengaged position and arranged to engage in a second rotational direction.

FIG. 12 is a perspective view of yet another construction of a clutch assembly embodying the invention with a portion of the clutch assembly removed for illustrative purposes and arranged to engage in a first rotational direction and free-wheel in a second rational direction.

FIG. 13 is a perspective view of the clutch assembly of FIG. 12 with the clutch assembly arranged to engage in the second rotational direction and free-wheel in the first rotational direction.

FIG. 14 is an exploded view of the clutch assembly of FIG. 12.

FIG. 15a illustrates a portion of the clutch assembly of FIG. 13 with an engagement member of the clutch assembly in a first axial position.

FIG. 15b illustrates a portion of the clutch assembly of FIG. 12 with the engagement member of the clutch assembly in a second axial position.

FIG. 16 is a perspective view of yet another construction of a clutch assembly embodying the invention with a portion of the clutch assembly removed for illustrative purposes.

FIG. 17 is a cross-sectional view of a portion of the clutch assembly of FIG. 16 taken along line 17-17 when the clutch assembly is arranged to free-wheel.

FIG. 18 is a cross-sectional view of a portion of the clutch assembly of FIG. 16 taken along line 18-18 of FIG. 16 when the clutch assembly is arranged to engage.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

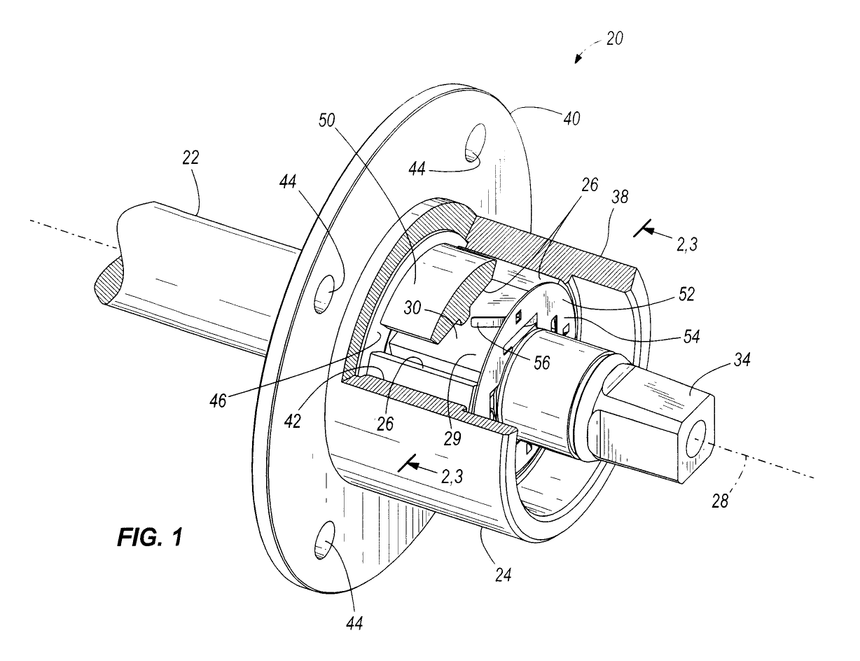

FIG. 1 illustrates a clutch assembly 20 that includes an inner member 22, an outer member 24, and engagement members 26 between the inner member 22 and the outer member 24. In the illustrated the construction, the inner member 22 is a shaft that is rotatable about an axis 28. While the illustrated inner member 22 is cylindrical along most of its lenght, the illustrated inner member 22 includes an engagement member support portion 29 that extends radially from the inner member 22 to define contact surfaces 30. In one construction, the engagement member support portion 29 can be integrally formed with the inner member 22, such as by machining, casting, molding, etc. In other constructions, the engagement member support portion 29 can be formed separate from the inner member 22 and subsequently coupled to the inner member 22.

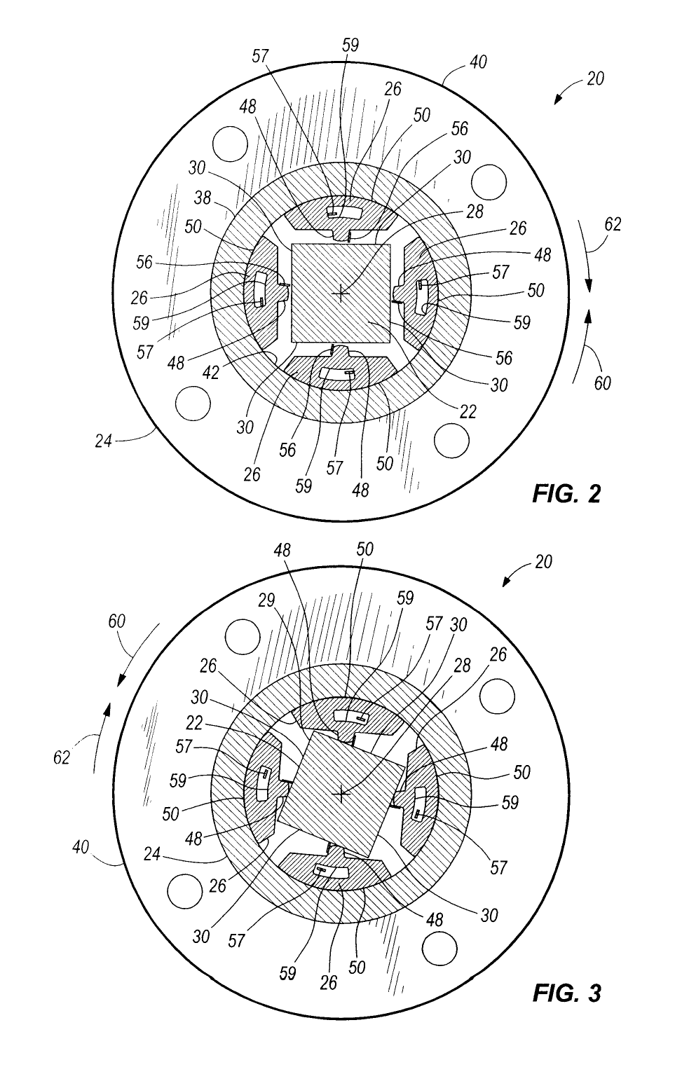

Referring to FIG. 2, in the illustrated construction, the contact surfaces 30 define a cross section of the inner member 22 that is substantially square. While the illustrated inner member 22 includes four contact surfaces 30, corresponding to four engagement members 26, in other constructions the inner member can include any suitable number of contact surfaces and the clutch assembly can includes any suitable number of engagement members.

Referring to FIG. 1, the illustrated inner member 22 functions as an input member and includes an input member coupling 34 in the form of a generally square end of the shaft. The input member coupling 34 can be used to couple any suitable member, such as a pulley, gear, sprocket, crank, and the like to the inner member 22 to rotate the inner member 22 about the axis 28. For example, in one construction the clutch assembly 20 is utilized in an exercise bicycle and the input member is a crank with a bicycle pedal attached to the crank. The crank is coupled to the input member coupling 34 such that rotation of the crank rotates the inner member 22 about the axis 28.

With continued reference to FIG. 1, the illustrated outer member 24, which is a hub in the illustrated construction, functions as an output member and includes a sleeve 38 and a flange 40. The sleeve 38 defines an outer member aperture 42 that receives the inner member 22 and the engagement members 26. The flange 40 includes a plurality of flange apertures 44. In one application of the clutch assembly 20, the sleeve 38 and flange apertures 44 are utilized to couple an output member coupling, such as a pulley, gear, sprocket, crank, wheel, and the like to the outer member 24.

While the outer member 24 and the inner member 22 have been described above, and will be described below as the output and input members respectively, one of skill in the art will understand that the outer member 24 can be the input member and the inner member 22 can be the output member.

Referring to FIG. 1, in the illustrated construction a bearing 46 is received within the outer member aperture 42 to facilitate relative rotation of the inner member 22 and the outer member 24 about the axis 28. The bearing 46 can be any suitable bearing such as a roller bearing, journal bearing, etc.

Referring to FIGS. 1 and 2, the illustrated engagement members 26, which are pads in the illustrated construction, include lobes 48 and engagement surfaces 50. The engagement surfaces 50 have a radius of curvature that is generally equal to the radius of curvature of the outer member aperture 42. In one construction, the engagement surfaces 50 of the engagement members 26 have a high coefficient of friction.

As best seen in FIG. 2, together the engagement surfaces 50 of the four engagement members 26 have a total circumference that is substantially more than half, and nearly equal to the circumference of the outer member aperture 42. While the illustrated clutch assembly 20 includes four engagement members 26, in other constructions the clutch assembly can include any suitable number of engagement members.

Referring to FIG. 1, the clutch assembly 20 further includes a blocking member 52, which is a spring washer in the illustrated construction. The illustrated blocking member 52 includes a base 54 and first projections 56 and second projections 57 that extend from the base 54.

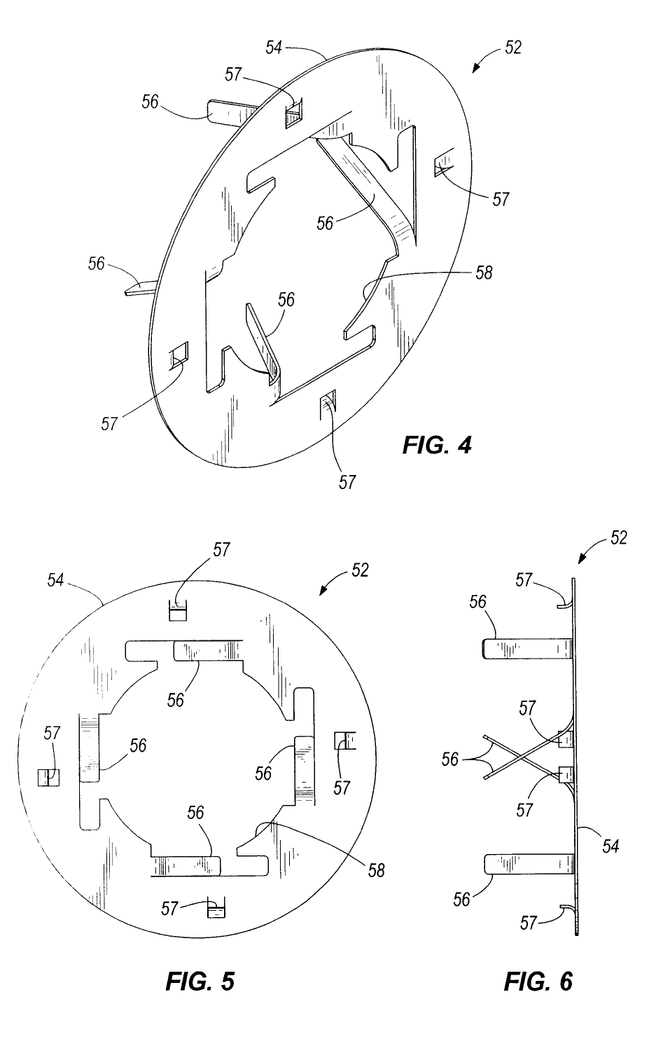

Referring to FIGS. 1 and 4-6, the illustrated base 54 is a generally thin flat washer member that defines a blocking member aperture 58. The blocking member aperture 58 is sized to receive the inner member 22 to couple the blocking member 52 to the inner member 22. In the illustrated construction, the base 54 is rotationally fixed with respect to the inner member 22 (i.e., the blocking member does not substantially rotate relative to the inner member 22).

The first projections 56 extend from the base 54 axially with respect the inner and outer members 22 and 24 and are elastically movable with respect to the base 54 to provide a spring type bias, the purpose of which will be discussed below. In other constructions, the first projections 56 may not provide a spring type bias. In the illustrated construction, four first propections 56 extend from the base 54 to correspond with the four engagement members 26. In other constructions, base member can include any suitable number of first projections.

Referring to FIGS. 1, 2, and 6, the illustrated second projections 57 are coupled to the engagement members 26 in slots 59 in the engagement members 26 that are wider than the second projections 57. In the illustrated construction, the slots 59 in the engagement members 26 extend axially and have a length slightly greater than the length of the second projections 57. While in the illustrated construction, the first projections 56 provide a spring type bias, the second projections 57 are substantially rigid and fixed with respect to the base 54 of the engagement member 52.

In one construction, the blocking member 52 is formed from a single piece of material, such as steel, including spring steel, aluminum, and the like that is stamped to create the first projections 56, the second projections 57, and the blocking member aperture 58. In other constructions, the blocking member can be formed using any suitable method and can be formed from any suitable material.

Referring to FIG. 2, in operation, when the inner member 22 rotates in a first direction relative to the outer member 24 (in the direction of arrow 60), the engagement members 26, which are allowed to rotate slightly with respect to the inner and outer members 22 and 24, rotate relative to the inner member 22 in an opposite second direction (in the direction of arrow 62). However, the first projections 56 of the blocking member 52 contact the lobes 48 of the engagement members 26 to prevent the engagement members 26 from rotating substantially with respect to the inner member 22 in the direction of the arrow 62. In some applications of the clutch assembly 20, the first projections 56 may not substantially prevent rotation of the engagement members 26. Therefore, the second projections 57 of the blocking member 52 contact the inner walls of the slots 59 in the engagement members 26 to ensure that the engagement members 26 do not rotate substantially with respect to the inner member 22 in the direction of the arrow 62.

Preventing the engagement members 26 from rotating in the direction of the arrow 62 maintains the lobes 48 of the engagement members 26 near the central portion of the contact surfaces 30. Because of the square cross section of the inner member 22, the clearance or distance between the inner member 22 and the outer member 24 is greatest at the center of the contact surfaces 30 and the clearance is large enough such that the engagement members 26 do not exert enough force on the outer member 24 to couple the inner and outer members 22 and 24 for co-rotation. Thus, the inner member 22 and the outer member 24 rotate with respect to each other (i.e., free-wheel or overrun) when the inner member 22 rotates in the first direction relative to the outer member 24 (in the direction of arrow 60).

Referring to FIG. 3, when the inner member 22 rotates in a second direction with respect to the outer member 24 (in the direction of arrow 62), the engagement members 26 rotate in the opposite direction (in the direction of arrow 60). Therefore, the lobes 48 of the engagement members 26 travel toward the ends or edges of the contact surfaces 30. Meanwhile, because of the width of the slot 59, the second projections 57 of the blocking member 52 do not inhibit substantial relative movement of the engagement members 26 in the direction of the arrow 60. Then, as the lobes 48 travel toward a portion of the inner member 22 with a greater outer dimension, and thus less clearance between the inner and outer members 22 and 24, the engagement members 26 engage the inner and outer members 22 and 24 to couple the input and output members 22 and 24 together for co-rotation. With the engagement members 26 in the position illustrated in FIG. 3 (i.e., engaged position), the engagement surfaces 50 and the lobes 48 of the engagement members 26 utilize friction to engage the inner member 22 and the outer member 24 to generally prevent relative rotation between the inner member 22 and the outer member 24 thereby transmitting torque from the inner member 22 to the outer member 24.

Referring to FIGS. 2, 3, and 4, in the illustrated construction the first projections 56 of the blocking member 52 engage the lobes 48 to bias the engagement members 26 toward the engaged position (in the direction of arrow 60) to reduce backlash in the clutch assembly 20. Reducing backlash reduces stress in the clutch assembly because when the input member is driven in the engaging direction the amount of rotation of the input member is minimized before the input member and the output member engage for co-rotation. In other constructions, the blocking member 52 may omit the first projections 56. In yet other constructions, the blocking member 52 may omit the second projections 57, and in such constructions the first projections 56 can prevent the engagement members 26 from moving into the engaged position during the operation illustrated in FIG. 2.

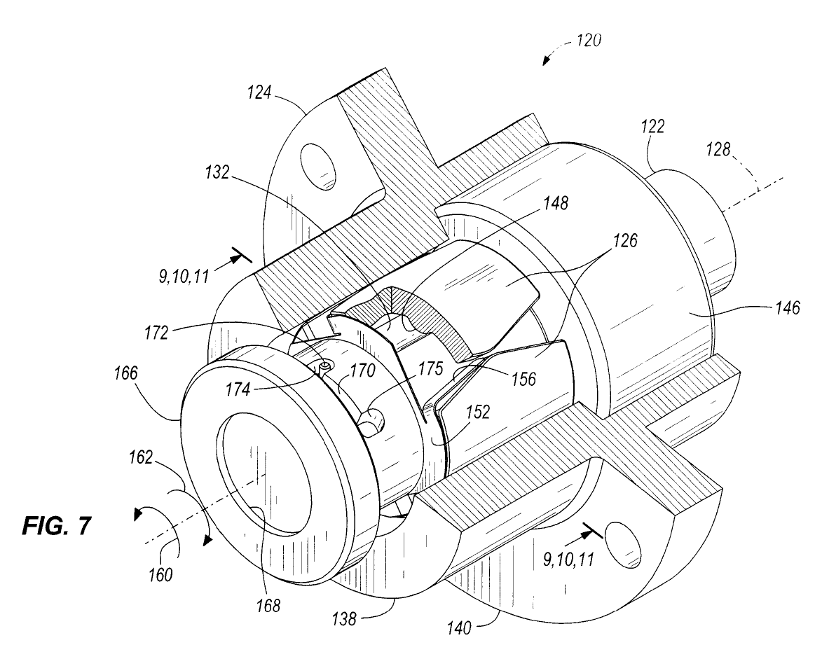

FIGS. 7-11 illustrate an alternative construction of a clutch assembly of the invention. Unlike the clutch assembly 20 of FIGS. 1-6, the clutch assembly 120 of FIG. 7-11 is a bi-directional clutch (i.e., can selectively free-wheel/overrun or engage in both rotational directions). Regardless, the clutch assembly 120 of FIGS. 7-11 is somewhat similar to the clutch assembly 20 of FIG. 1-6 and like components have been given like reference numbers plus one-hundred, and only the general differences will be discussed in detail below.

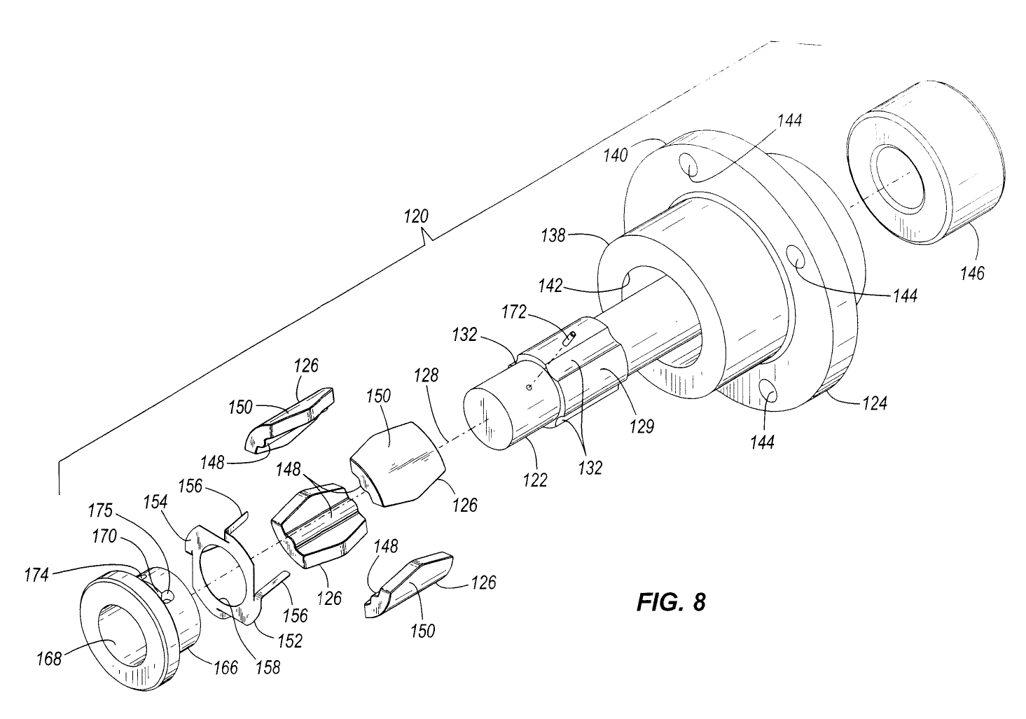

Referring to FIGS. 7 and 8, the illustrated clutch assembly 120 further includes an adjustment member 166 that is selectively rotatable with respect to the inner member 122. The illustrated adjustment member 166 includes a bore 168 that receives the inner member 122 and a slot 170 that receives a pin 172 that is fixed to the inner member 122. The slot 170 includes a first enlarged portion 174 and a second enlarged portion 175 at opposite ends of the slot 170. A first position of the adjustment member 166 is defined when the adjustment member 166 is positioned with respect to the inner member 122 such that the pin 172 is received in the first enlarged portion 174 of the slot 170 (FIG. 7) and a second position is defined with the pin 172 is received in the second enlarged portion 175 of the slot 170, the purpose of which will be discussed below.

In the illustrated construction, the adjustment member 166 is fixed for rotation with the blocking member 152 such that rotation of the adjustment member 166 results in rotation of the blocking member 152.

While not illustrated, an actuator, which can be pneumatic, hydraulic, manual, electric etc., can be coupled to the adjustment member 166 to rotate the adjustment member 166 with respect to the inner member 122 in order to rotate the adjustment member 166 into the first and second adjustment member positions described above.

Referring to FIG. 8, the engagement member support portion 129 of the inner member 122 is generally cylindrical and includes recesses 132. As illustrated in FIG. 7, the recesses 132 receive the lobes 148 of the engagement members 126.

With continued reference to FIG. 8, the illustrated blocking member 152 includes the projections 156 that contact tapered sides of the engagement members 126 between adjacent engagement members 126. The illustrated blocking member 152 omits the second projections 57 of the blocking member 52 of FIGS. 1-6. However, in other constructions the blocking member 152 can include second projections similar to the second projections 57 of the blocking member 152 of FIGS. 1-6. In such constructions, the engagement members 126 of the clutch assembly 120 can include slots similar to the slots 59 of the engagement members 26 of FIGS. 1-6.

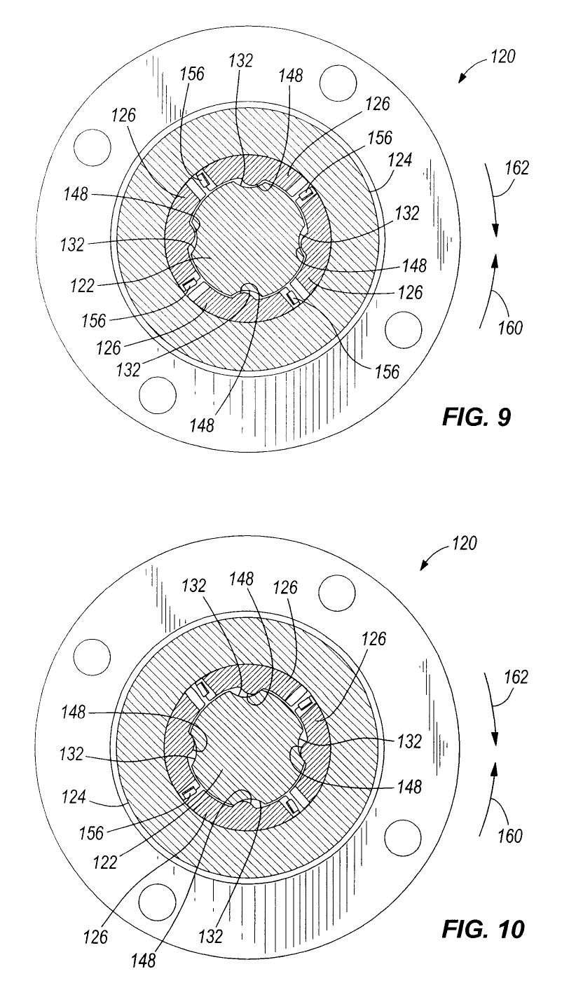

Referring to FIGS. 7 and 9, in operation, with the adjustment member 166 in the first adjustment member position, the projections 156 of the blocking member 152 bias the engagement members 126 in the direction of the arrow 162. When the inner member 122 rotates in a first direction relative to the outer member 124 (in the direction of arrow 162) the projections 156 prevent substantial rotation of the engagement members 126 with respect to the inner member 122 in the direction of the arrow 160. Therefore, the lobes 148 generally do not travel into the shallow portion of the recesses 132. While the engagement members 126 remain in contact with the outer member 124, the lobes 148 remain in a portion of the recesses 132 that provides enough clearance between the inner and outer members 122 and 124 such that the engagement members 126 are prevented from coupling or engaging the inner and outer members 122 and 124 for co-rotation. Thus, the outer member 124 is allowed to rotate, free-wheel, or overrun with respect to the inner member 122 when the inner member 122 rotates in the first rotational direction (in the direction of arrow 162) relative to the outer member 124. Again, if projections 156 cannot prevent such relative rotation, second projections and slots in the engagement members similar to the projections 57 and slots 59 can be utilized.

Referring to FIG. 10, if the inner member 122 rotates in a second direction (in the direction of arrow 160) relative to the outer member 124, the engagement members 126 will rotate with respect to the inner member 122 in the direction of the arrow 162. As the engagement members 126 rotate with respect to the inner member 122, the lobes 148 of the engagement members 126 move along the recesses 132. As the lobes 148 move toward the shallow portion of the recess 132 the clearance between the inner and outer members 122 and 124 at the shallow portion of the recess 132 is less than the clearance at the central or deeper portions of the recess 132. Therefore, the engagement members 126 engage the inner and outer members 122 and 124 for co-rotation. As discussed above with regard to FIG. 3, when the engagement members 126 engage the inner and outer members 122 and 124, the inner and outer members 122 and 124 generally rotate together and torque is transmitted from the inner member 122 to the outer member 124.

Referring to FIG. 7, with the adjustment member 166 in the first position as illustrated in FIG. 7 and as discussed above, the clutch assembly 120 engages (i.e., torque is transmitted between the inner and outer members 122 and 124) when the inner member 122 rotates relative to the outer member 124 in the direction of the arrow 160 and the inner and outer members 122 and 124 generally free-wheel or overrun when the inner member 122 rotates in the direction of the arrow 162 relative to the outer member 124.

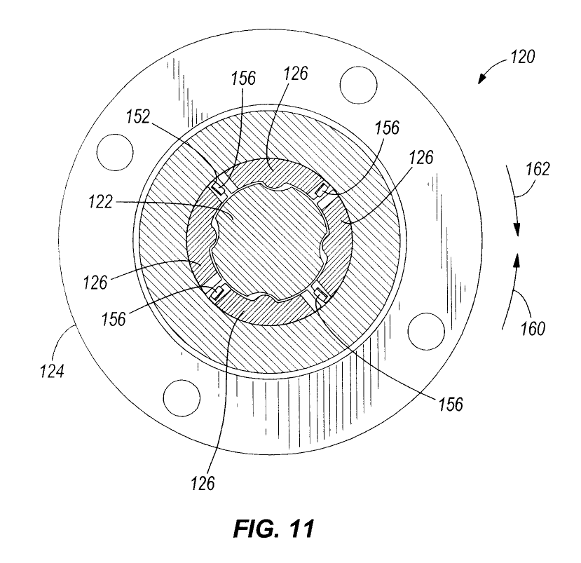

Referring to FIG. 7 and 11, the user can change the free-wheeling/overruning and engaging directions by moving the adjustment member 166 to the second position (FIG. 11). The illustrated adjustment member 166 is moved to the second position by rotating the adustment member 166 with respect to the inner member 122 such that the pin 172 is received in the second enlarged portion 175 of the slot 170. Rotation of the adjustment member 166 produces a corresponding rotation of the blocking member 152. As illustrated in FIG. 11, with the adjustment member 166 and the blocking member 152 in the second position, the projections 156 of the blocking member 152 bias the engagement members 126 in the direction of the arrow 160. Therefore, with the projections 156 in the position as illustrated in FIG. 11, the inner and outer members 122 and 124 will free-wheel when the inner member 122 rotates in the direction of arrow 160 relative to the outer member 124. The inner and outer members 122 and 124 will engage for rotation together when the inner member 122 rotates in the direction of arrow 162 relative to the outer member 124.

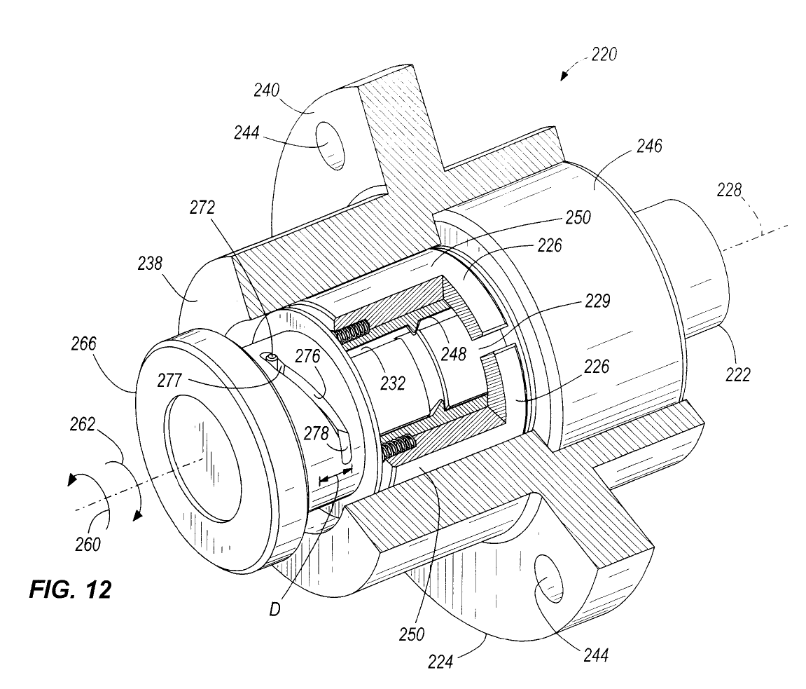

FIGS. 12-15b illustrate yet another construction of a clutch assembly. Similar to the clutch assembly 120 of FIGS. 7-11, the clutch assembly 220 of FIGS. 12-15b is a bi-directional clutch. Therefore, the user can select the relative rotational direction in which the inner and outer members will engage and free-wheel or overrun. Components of the clutch assembly 220 that are similar to the components of the clutch assembiles 20 and 120 have been given like reference numbers in the two-hundred series, and only the general differences will be discussed in detail below.

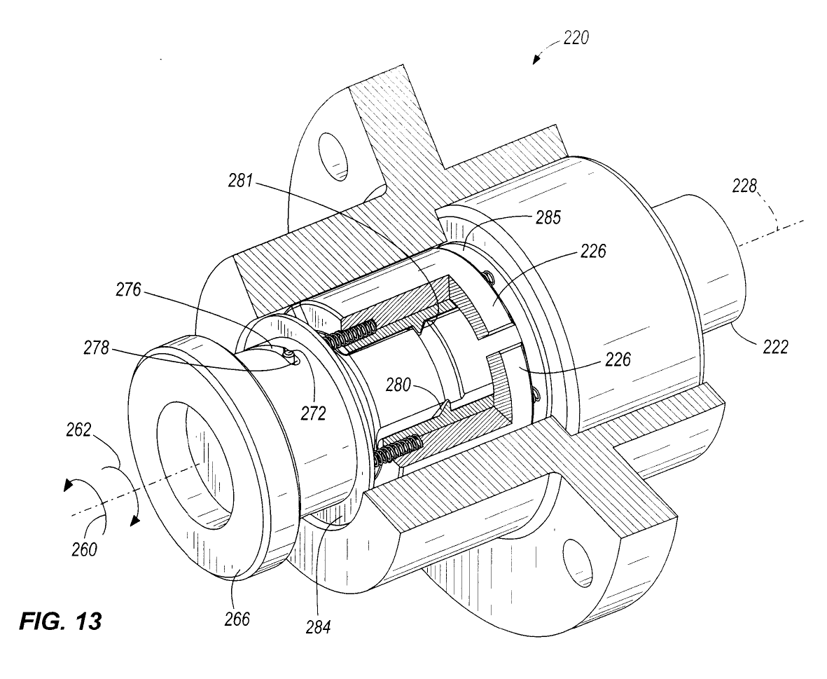

Referring to FIGS. 12 and 13, the illustrated adjustment member 266 includes a cam-slot 276. The cam-slot 276 includes a first end portion 277 and a second end portion 278 spaced axially from the first end portion 277 by a distance D (See FIG. 12). The first adjustment member position is defined when the pin 272 is received in the first end portion 277 (FIG. 12) and the second adjustment member position is defined when the pin 272 is received in the second end portion 278 (FIG. 13).

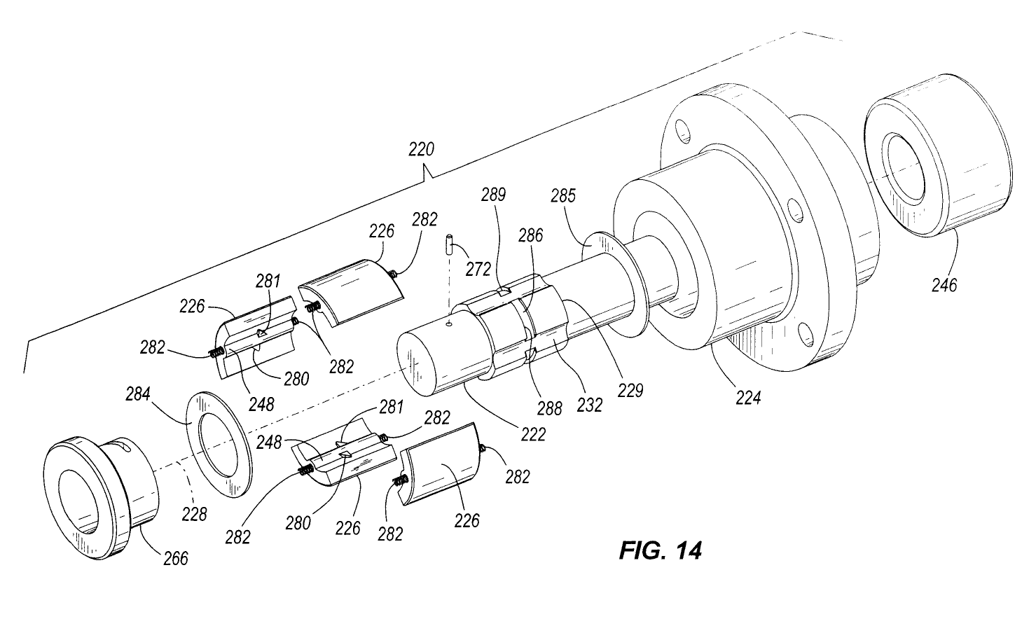

Referring to FIG. 14, the illustrated engagement members 226 each include a first cam surface 280 and a second cam surface 281. Biasing members 282 are coupled to both ends of the engagement members 226. While the illustrated biasing members 282 are coil springs in other constructions the biasing members can be any suitable biasing member. In the illustrated construction, the biasing members 282 are coupled to either a first washer plate 284 or a second washer plate 285 located adjacent the opposite ends of the engagement members 226. In the illustrated construction, the first and second washer plates 284, 285 rotate with the biasing members 282, which are fixed for rotation with the engagement members 226. Furthermore, in the illustrated construction, the first washer plate 284 is coupled to the inner member 222 such that the first washer plate 284 can move along the axis 228 while the second washer 285 plate abuts the bearing 246 such that the movement of the second washer plate 285 along the axis 228 is inhibited in at least one direction.

With continued reference to FIG. 14, the engagement member support portion 229 of the inner member 222 further includes a cam receiving recess 286 that extends circumferentially around the engagement member support portion 229. The cam receiving recess 286 receives the cam surfaces 280 and 281 of the engagement members 226. The cam receiving recess 286 and the recess 232 define corners 288a-288d. In the illustrated construction, the comers 288a-288d have a radius.

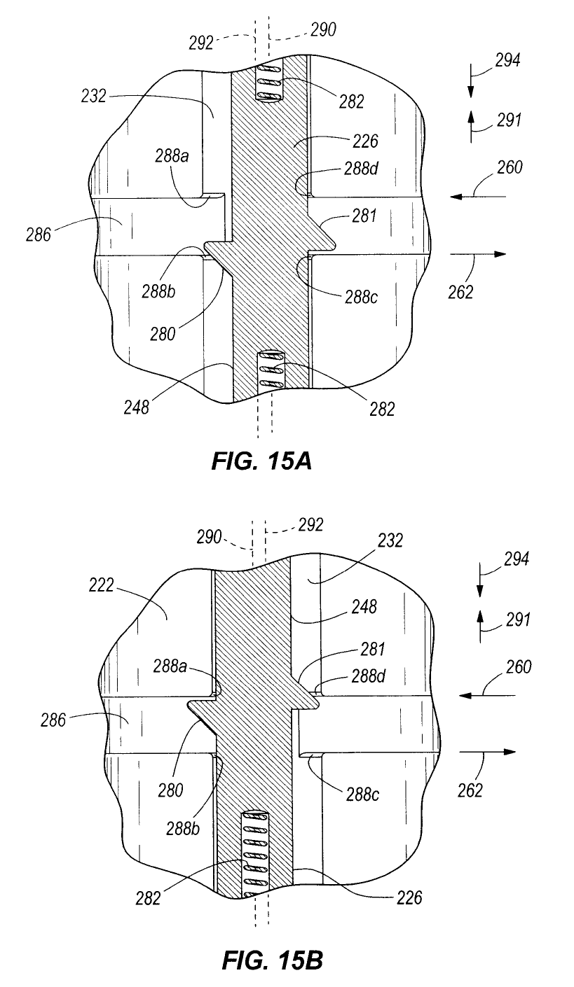

Referring to FIG. 12 and 15b, in operation, when the adjustment member 266 is in the first position, the engagement members 226 are in a first axial position. As best seen in FIG. 15b, with the engagement members 226 in the first axial position, the second cam surface 281 engages the comer 288d of the cam receiving recess 286 and the recess 232. Because of the engagement between the comer 288d and the second cam surface 281, when the engagement member 226 moves into the first axial position in the direction indicated by the arrow 291, the engagement member rotates slightly with respect to the inner member 222 in the direction indicated by the arrow 260, offsetting a central axis 290 of the lobe 248 from a central axis 292 of the recess 232. Such an offset positions the engagement members 226 closer to the engaged position to minimize the backlash of the clutch assembly 220. Therefore, the inner and outer members 222 and 224 engage with relatively little relative rotation between the inner and outer members 222 and 224.

Referring to FIGS. 12, 14 and 15b, when the inner member 222 rotates in the direction of the arrow 262 relative to the outer member 224, the engagement members 226 rotate with respect to the inner member 222 in the direction of the arrow 260. As the engagement members 226 rotate with respect to the inner member 222, the lobes 248 of the engagement members 226 move toward the shallow portion of the recess 232 causing the engagement members 226 to couple or engage the inner and outer members 222 and 224 for co-rotation as discussed above with respect to the clutch assemblies 20 and 120 of FIGS. 1-11. Therefore, torque is transmitted from the inner member 222 to the outer member 224 when the adjustment member 266 is in the first position (FIG. 12) and the inner member rotates in the direction of the arrow 262 relative to the outer members 224.

With continued reference to FIGS. 12, 14, 15b, with the adjustment member 266 in the first position, when the inner member 222 rotates in the direction of the arrow 260 relative to the outer member 224, the inner and outer members 222 and 224 free-wheel or overrun. As best seen in FIG. 15b, when the inner member 222 rotates in the direction of the arrow 260 relative to the outer member 224 (FIG. 12) the engagement members 226 are forced to rotate with respect to the inner member 222 in the direction of the arrow 262. However, the second cam surface 281 engages the corner 288d of the cam receiving recess 286 and recess 232. As the engagement member 226 rotates in the direction of the arrow 262, the engagement members 226 tends to move axially in the direction of the arrow 294. However, the biasing members 282 inhibit movement of the engagement members 226 in the direction of the arrow 294, thereby preventing substantial movement of the engagement members 226 in the direction of arrow 262. Thus, the lobes 248 of the engagement members remain in the deep portions of the recesses 232 and the engagement members 226 generally do not engage the outer member 224 allowing the inner member 222 to free-wheel relative to the outer member 224.

With the adjustment member 266 in the first position as illustrated in FIG. 12, the clutch assembly 220 engages when the inner member 222 rotates in the direction of the arrow 262 relative to the outer member 224. The inner and outer members 222 and 224 generally free-wheel or overrun when the inner member 222 rotates in the direction of the arrow 260 relative to the outer member 224.

Referring to FIGS. 12, 13 and 15a, the user can change the free-wheeling/overruning and engaging directions of the clutch assembly 220 by rotating the adjustment member 266 to the second position as illustrated in FIGS. 13 and 15a. In the illustrated construction, rotating the adjustment member 266 with respect to the inner member 222 in the direction of the arrow 260 causes the adjustment member 266 to move axially with respect to the inner member 222 the distance D (FIG. 12). Moving the adjustment member 266 from the first position (FIG. 12) to the second position (FIG. 13) causes the engagement members 226 to move in the direction of the arrow 294 from the first axial position (FIG. 15b) to a second axial position (FIG. 15a). Furthermore, because the first cam surface 280 engages the corner 288b of the cam receiving recess 286 and the recess 232, the engagement members 226 rotate slightly with respect to the inner member 222 in the direction of the arrow 262, offsetting the central axis 290 of the lobe 248 from the central axis 292 of the recess 232. As discussed above, such an offset reduces the backlash of the clutch assembly 220.

For the reasons set forth above with regard to FIGS. 12 and 15b, with the adjustment member 266 in the second position as illustrated in FIGS. 13 and 15a, the clutch assembly 220 engages when the inner member 222 rotates in the direction of the arrow 260 relative to the outer member 224 and the inner and outer members 222 and 224 free-wheel/overrun when the inner member 222 rotates in the direction of the arrow 262 relative to the outer member 224.

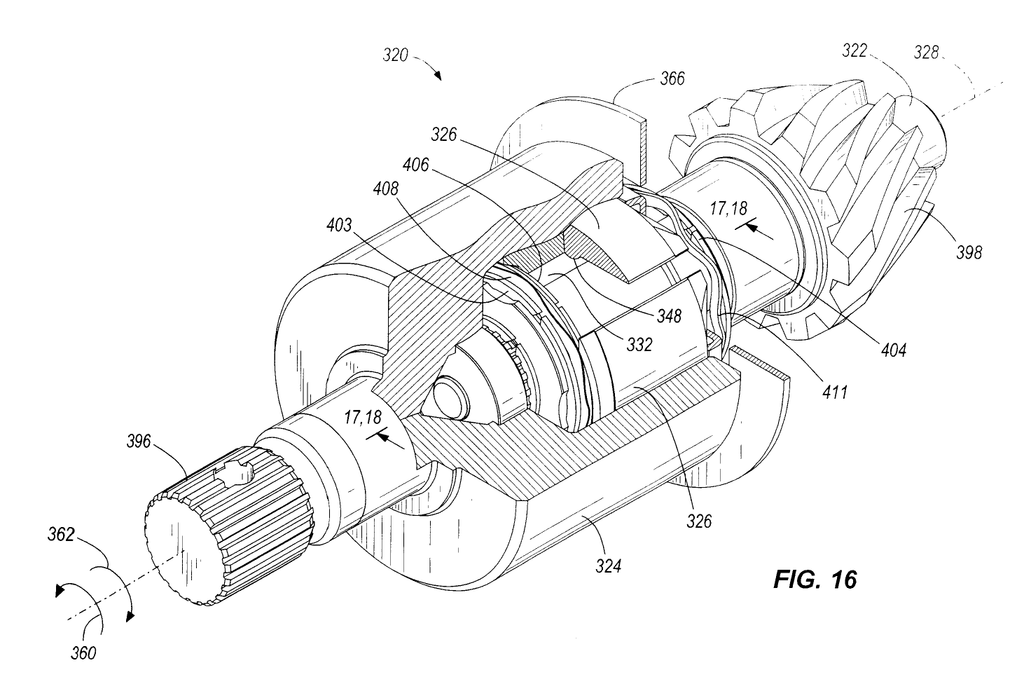

FIGS. 16-18 illustrate yet another construction of a clutch assembly of the invention. The clutch assembly 320 of FIGS. 16-18 is similar to the clutch assemblies 20, 120, and 220 of FIGS. 1-15b and like components have been given like reference numbers in the three-hundred and four-hundred series, and only the general differences will be discussed in detail below.

In the illustrated construction, the clutch assembly 320 engages when the inner member 322 rotates in either direction relative to the outer member 324. However, the user can configure the clutch assembly 320 such that when the inner member 322 rotates in either direction relative to the outer member 324, the inner and outer members 322 and 324 free-wheel or overrun.

Referring to FIG. 16, the clutch assembly 320 includes the inner member 322 and the outer member 324. The illustrated outer member 324 is coupled to a splined portion 396, and the illustrated inner member 322 includes a gear 398 that is coupled to the inner member 322.

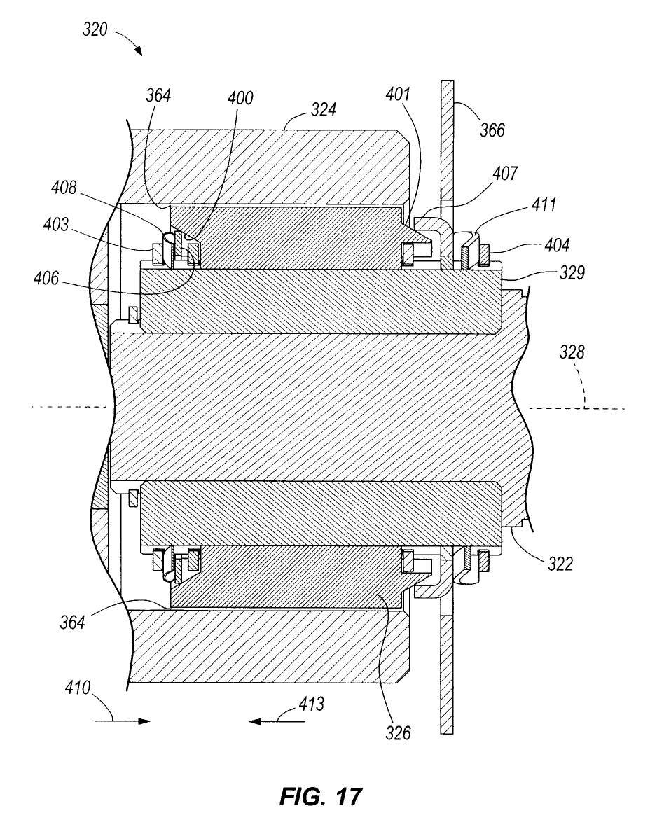

Referring to FIG. 17, each engagement member 326 includes a first ramp surface 400 and a second ramp surface 401. The illustrated clutch assembly 320 further includes a first fixed ring 403, a second fixed ring 404, an axially movable ring 406 and an adjustment member 366 having an axially extending flange 407.

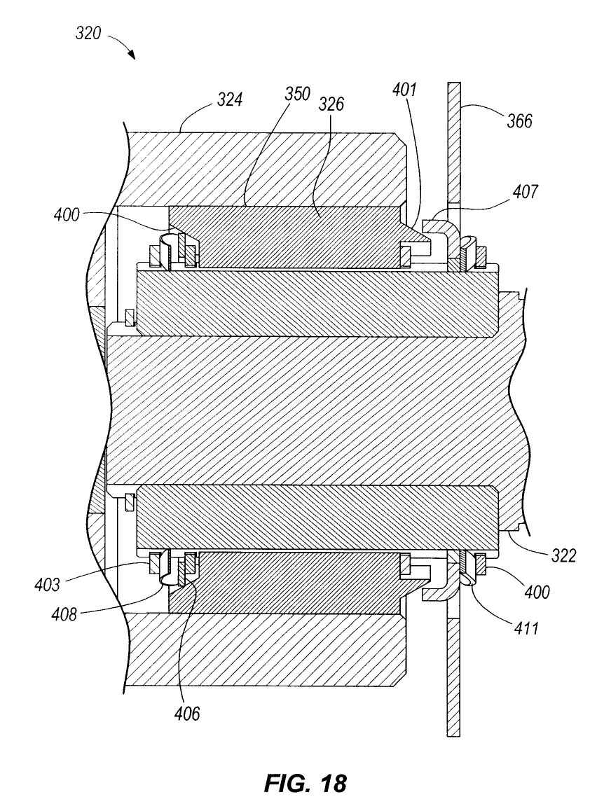

The adjustment member 366 is axially movable with respect to axis 328 of the clutch assembly 320 from a first position (FIG. 17) to a second position (FIG. 18). While not illustrated, an actuator, such as a pneumatic, hydraulic, electric, or manual actuator and the like can be coupled to the adjustment member 366 to move the adjustment member axially with respect to the axis 328.

With continued reference to FIG. 17, a first biasing member 408, which is a wave spring in the illustrated construction, acts against the first fixed ring 403 and the movable ring 406 to bias the movable ring 406 in the direction of the arrow 410. A second biasing member 411, which is a wave spring in the illustrated construction, acts against the second fixed ring 404 and the adjustment member 366 to bias the adjustment member 366 in the direction of the arrow 413.

Referring to FIG. 17, in operation, the second biasing member 411 biases the adjustment member 366 into the first adjustment member position as illustrated in FIG. 17. While not illustrated, the actuator described above that can be coupled to the adjustment member 366 may hold the adjustment member 366 in the first position. With the adjustment member 366 in the first position, the flange 407 of the adjustment member 366 contacts the second ramp surface 401 of the engagement member 326 to bias the engagement member 326 toward the inner member 322. Therefore, the gap 364 is maintained between the engagement members 326 and the outer member 324.

The first biasing member 408 biases the movable ring 406 in the direction of the arrow 410, which contacts the first ramp surface 400 to bias the engagement member 326 toward the outer member 324. However, the inward force exerted on the engagement member 326 by the flange 407 of the adjustment member 366 is greater than the outward force exerted by the movable ring 406 on the engagement members 326. Therefore, the gap 364 is maintained between the engagement members 326 and the outer member 324.

Referring to FIGS. 16 and 17, when the outer member 324 rotates about the axis 328 in either of the directions of the arrows 360 or 362 relative to the outer member 322, the lobes 348 tend to move with respect to the recess 322 causing the engagement members 326 to tend to move radially with respect the inner member 322 toward the outer member 324. However, the radial inward force exerted by the flange 407 on the second ramp surface 401 of the engagement member 326 prevents the lobes 348 from moving or rotating toward the shallow portion of the recess 332. Therefore, the gap 364 remains between the inner and outer members 322 and 324 to allow the outer member 324 to free-wheel or rotate with respect to the inner member 322.

Referring to FIG. 16 and 18, if the adjustment member 366 is moved axially with respect to the inner member 322 in the direction of the arrow 410 from the first position (FIG. 17) to the second position (FIG. 18), the flange 407 of the adjustment member 366 moves down the second ramp surface 401 of the engagement members 326, such that, in the illustrated construction, a gap is created between the ramp surface 410 and the flange 407. The actuator, which can be coupled to the adjustment member, may hold the adjustment member 366 in the second position.

Movement of the flange 407 down the second ramp surface 401 allows the first biasing member 408 to move the engagement members 326 radially toward the outer member 324 or toward the engaged position. As a result of the biasing member 408 biasing and moving the engagement members 326 toward the engaged position, backlash is reduced in the clutch assembly 320.

While not illustrated, in other constructions the clutch assembly 320 of FIGS. 16-18 may include a blocking member similar to the blocking members 52 and 152 of the clutch assemblies 20 and 120 of FIGS. 1-11 to further reduce backlash in the clutch assembly 320 as described above with regard to FIGS. 1-11.

With the adjustment member 366 in the second position, when the outer member 324 rotates about the axis 328 in either of the directions of the arrows 360 or 362 relative to the inner member 322, the lobes 348 of the engagement members 326 move into the shallow portions of the recesses 332 because of the friction between the engagement surfaces 350 of the engagement members 326 and the outer member 324. With the lobes 348 in the shallow portion of the recesses 332, the engagement members 326 couple or engage the inner and outer members 322 and 324 for co-rotation. Thus, torque is transmitted from the outer member 324 to the inner member 322.

To disengage the clutch assembly 320, the user can move the adjustment member 366 back to the first position (FIG. 17), which allows the inner and outer members 322 and 324 to free wheel in both rotational directions about the axis 328.

While the outer member 324 and the inner member 322 have been described above in reference to FIGS. 16-18 as the input and output members respectively, as would be understood by one of skill in the art, in other constructions the outer member can be the output member and the inner member can be the input member.

In one application, the clutch assembly 320 of FIGS. 16-18 can be utilized in a four-wheel drive vehicle. In such an application, the clutch assembly 320 can be engaged to drive a second set of wheels (four-wheel drive mode) and disengaged such that the second set of wheels free-wheel (two-wheel drive mode).

Various features and advantages of the invention are set forth in the following claims.

What is claimed is:

1. A clutch assembly comprising:
an input member rotatable about an axis;
an output member rotatable about the axis;
an engagement member having a portion between the input member and the output member, wherein the engagement member is operable to selectively couple the input and output members together for co-rotation; and
a blocking member including a base and a projection that extends from the base, the projection coupled to the engagement member to substantially prevent the engagement member from coupling the input and output members together for co-rotation when the input member rotates in a first direction relative to the output member, while allowing the engagement member to couple the input and output members together for co-rotation when the input member rotates in a second direction relative to the output member.

2. The clutch assembly of claim 1, wherein the base of the blocking member includes an aperture that receives one of the input and output members.

3. The clutch assembly of claim 1, wherein the blocking member is integrally formed as a single piece by stamping.

4. The clutch assembly of claim 1, wherein the base is a generally thin flat washer member.

5. The clutch assembly of claim 1, wherein the engagement member includes an aperture, and wherein the projection is received in the aperture of the engagement member.

6. The clutch assembly of claim 1, wherein the projection is elastically movable with respect to the base such that the projection biases the engagement member toward coupling the input and output members together for co-rotation.

7. The clutch assembly of claim 1, wherein the projection is a first projection and wherein the blocking member further includes a second projection that biases the engagement member toward coupling the input and output members together for co-rotation.

8. The clutch assembly of claim 1, wherein the projection extends axially from the base.

9. The clutch assembly of claim 1, wherein at least a portion of the blocking member is selectively movable from a first blocking member position that enables the input and output members to generally rotate together when the input member rotates in the first direction relative to the output member and rotate with respect to each other when the input member rotates in the second direction relative to the output member to a second blocking member position that enables the input and output members to generally rotate together when the input member rotates in the second direction relative to the output member and rotate with respect to each other when the input member rotates in the first direction relative to the output member.

10. The clutch assembly of claim 9, further comprising an adjustment member coupled to the blocking member, the adjustment member rotatable to position the blocking member in the first and second blocking member positions.

11. The clutch assembly of claim 9, wherein the projection of the blocking member is a first projection, the blocking member further including a second projection, and wherein the first projection acts on the engagement member when the blocking member is in the first blocking member position and the second projection acts on the engagement member when the blocking member is in the second blocking member position.

12. A bi-directional clutch assembly comprising:
an input member rotatable about an axis;
an output member rotatable about the axis; and
an engagement member having a portion between the input and output members, wherein the engagement member is movable between a first axial position that enables the input and output members to generally rotate together when the input member rotates in a first direction relative to the output member and rotate with respect to each other when the input member rotates in a second direction relative to the output member and a second axial position that enables the input and output members to generally rotate together when the input member rotates in the second direction relative to the output member and rotate with respect to each other when the input member rotates in the first direction relative to the output member.

13. The bi-directional clutch assembly of claim 12, wherein movement of the engagement member from the first axial position to the second axial position causes the engagement member to rotate in one of the first and second directions about the axis.

14. The bi-directional clutch assembly of claim 13, wherein the engagement member includes a cam surface that causes the engagement member to rotate in the first direction when the engagement member is moved from the first axial position to the second axial position.

15. The bi-directional clutch assembly of claim 14, wherein the engagement member includes a second cam surface that causes the engagement member to rotate in the second direction when the engagement member is moved from the second axial position to the first axial position.

16. The bi-directional clutch assembly of claim 12, further comprising an adjustment member rotatable in one of the first and second directions to move the engagement member from the first axial position to the second axial position.

17. The bi-directional clutch assembly of claim 16, wherein the adjustment member includes a cam-slot that translates rotational motion of the adjustment member to axial motion of the adjustment member to axially move the engagement member.

18. The bi-directional clutch assembly of claim 12, further comprising a biasing, member that inhibits movement of the engagement member between the first and second axial positions.

19. The bi-directional clutch assembly of claim 12, wherein the engagement member includes one of a lobe and a recess, wherein the other of the lobe and the recess is generally fixed with respect to one of the input and output members, and wherein the lobe and the recess move with respect to each other such that the engagement member couples the input and output members together for co-rotation.

20. The bi-directional clutch assembly of claim 12, wherein the engagement member utilizes friction to engage the input and output members to generally prevent rotation of the input member with respect to the output member.

21. The bi-directional clutch assembly of claim 12, wherein the input member is one of a shaft and a hub and the output member is the other of the shaft and the hub.

22. A clutch assembly comprising:
an input member rotatable about an axis;
an output member rotatable about the axis;
an engagement member having a portion between the input and output members, the engagement member operable to selectively couple the input and output members together for co-rotation; and
an adjustment member axially movable relative to the input member between a first position and a second position,
wherein the engagement member is prevented from coupling the input and output members together for co-rotation when the adjustment member is in the first position and the engagement member is allowed to couple the input and output members together for co-rotation when the adjustment member is in the second position.

23. The clutch assembly of claim 22, wherein the engagement member includes an engagement surface selectively engaged with the adjustment member.

24. The clutch assembly of claim 22, further comprising a biasing member that biases the engagement member toward coupling the input and output members together for co-rotation.
